(19) United States
(12) Patent Application Publication
(10) Pub. No.: US 2006/0010740 A1
(43) Pub. Date: Jan. 19, 2006

(54) Method and apparatus for creating an optical illusion

(76) Inventor: James P. Fay, Rutland, MA (US)

Correspondence Address: MCCORMICK, PAULDING & HUBER LLP, CITY PLACE II, 185 ASYLUM STREET, HARTFORD, CT, 06103, US

(21) Appl. No.: 11/181,309

(22) Filed: Jul. 14, 2005

Related U.S. Application Data
(60) Provisional application No. 60/587,659, filed on Jul. 14, 2004.

(51) Int. Cl. G09F 17/00

(52) U.S. Cl. 40/604

(57) ABSTRACT

An apparatus for creating an optical illusion in the structural opening of a building includes a flexible web having an image disposed thereon and a fastening mechanism integrally formed with the flexible web so as to operatively interact with the structural opening to selectively fasten the flexible web to the structural opening. An integral biasing mechanism is formed with the flexible web for biasing the flexible web in an unfurled manner.

### CROSS REFERENCE TO RELATED APPLICATIONS

This application claims the benefit of U.S. Provisional Application Ser. No. 60/587,659, filed on Jul. 14, 2004.

### FIELD OF THE INVENTION

This invention relates in general to a method and apparatus for creating an optical illusion, and deals more particularly with a method and apparatus for creating an optical illusion that utilizes a banner to create an optical illusion for aesthetic and/or entertainment purposes.

### BACKGROUND OF THE INVENTION

The art of optical illusion has long been practiced by those wishing to entertain, amuse or deceive others. In addition, optical illusions have also been utilized to beautify public and private spaces. Typically, however, optical illusions are complex to construct and oftentimes require expensive and technologically advanced electronics to implement.

One area of a typical home that is commonly regarded as utilitarian, as opposed to being aesthetically enticing, is the garage. Indeed, homeowners have been known to spend significant amounts of money on customized garage doors, and the like, in order to soften the utilitarian aspect and appearance of the garage as a whole.

While customized garage doors and the like are effective to a certain degree in augmenting the appearance of a garage, they are often expensive to purchase and largely incapable of profiling the personality of the homeowner, or of offering any entertainment value.

With the forgoing problems and concerns in mind, it is the general object of the present invention to provide a method and apparatus for creating an optical illusion that overcomes the above-described drawbacks, while also softening the utilitarian aspects and appearance of typically utilitarian openings in a manner that amuses and entertains.

### SUMMARY OF THE INVENTION

It is an object of the present invention to provide a method and apparatus for creating an optical illusion.

It is another object of the present invention to provide a method and apparatus for creating an optical illusion that utilizes a banner.

It is another object of the present invention to provide a method and apparatus for creating an optical illusion that utilizes a banner disposed in the opening formed in a building.

It is another object of the present invention to provide a method and apparatus for creating an optical illusion that utilizes a garage door banner to produce the optical illusion.

It is another object of the present invention to provide a garage door banner that is relatively inexpensive.

It is another object of the present invention to provide a garage door banner that is easy to assemble and disassemble.

It is another object of the present invention to provide a garage door banner that can be tailored to the particular personality of the homeowner.

These and other objectives of the present invention, and their preferred embodiments, shall become clear by consideration of the specification, claims and drawings taken as a whole.

### BRIEF DESCRIPTION OF THE DRAWINGS

FIG. 1 is a front, elevational view of a garage door banner installed in a garage door opening, in accordance with one embodiment of the present invention.

FIG. 2 is a front, elevational view of the garage door banner shown in FIG. 1 and depicting securing means for the same.

FIG. 3 is a cross-sectional view the garage door banner, according to one embodiment of the present invention.

### DETAILED DESCRIPTION OF THE PREFERRED EMBODIMENT

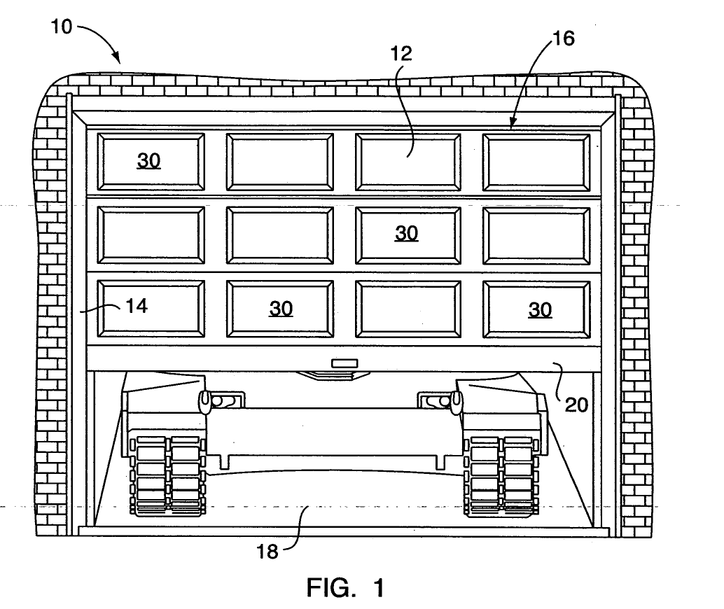

FIG. 1 illustrates a front, elevational view of a typical garage door area 10 of a residential building. As is commonly known, a garage door 12 is typically bordered by a garage door molding 14, or the like, and the garage door 12 may be selectively moved so as to open or close the garage door 12 by a predetermined amount.

Although the garage door area 10 is envisioned to be either a stand-alone garage area or a garage area attached to a residential dwelling, it will be readily appreciated that the present invention is equally applicable to any doorway, opening, archway or the like, of any structure, shed, house, tent or building, residential or commercial, without departing from the broader aspects of the present invention.

Returning to FIG. 1, it can be seen that the garage door 12 is in a partially open position, whereby the top portion 16 of the garage door 12 has been shifted upwards and rotated into the garage itself, as is typically known. Also shown in FIG. 1 is the attachment of a flexible image bearing banner, or web, 18 extending downwardly from the bottom portion 20 of the garage door 12.

As will be readily appreciated by a review of FIG. 1, the garage door banner 18 is designed to hang from the bottom portion 20 of the garage door 12 so as to impart the optical illusion of a fanciful vehicle, or the like, residing within the garage itself. Although as represented in FIG. 1 the fanciful vehicle is shown as a tank, the present invention envisions that any type of image may be impregnated upon the banner 18 without departing from the broader aspects of the present invention. Indeed, a non-exhaustive list of the nature of the impregnated images capable of being represented upon the banner 18 is any type of land or sea vehicle, aircraft, military vehicle or weaponry, as well as any depictions of animals, people or plant life.

The banner 18 depicted in FIG. 1 may be formed from any number of suitable materials, including but not limited to plastic, vinyl, canvas, wire or fabric mesh, nylon, fiberglass or the like. In this regard, and as utilized in conjunction with the banner 18, the term ‘web’ is meant to denote any known substrate upon which an image can be printed or otherwise applied thereto. That is, the web, or banner, 18 maybe formed from any known woven or non-woven material without departing from the broader aspects of the present invention.

Moreover, the images defined upon the banner 18 may be formed thereon via any known and material-appropriate method, such as but not limited to silk screening, photographic printing or even created via the intersection of differing colored threads which, when viewed at a distance, create the desired image.

It is therefore an important aspect of the present invention that the proposed banner 18 may be hung or otherwise displayed in an opening of a building, structure or other defined and bordered area. When hung in the manner depicted in FIG. 1, the banner 18 produces the optical illusion of content, especially when viewed from a measured distance such as the typical distance from a garage to the adjacent street of a typical residential housing unit, or the like. That is, when viewed from a measured distance, the banner 18 of the present invention produces the fanciful and provocative impression that some unexpected or preposterous vehicle (e.g., a tank), animal (e.g., a rhinoceros) or nature scene (e.g., a waterfall) is housed within the garage itself.

It is another important aspect of the present invention that the optical illusion created by the banner 18 need not involve complicated or expensive electronics, which may themselves be difficult to maintain over time, or during inclement weather.

It will also be readily appreciated that by forming the banner 18 from a mesh or weave of material, that the banner 18 may permit the flow of air into and out of the garage itself. Thus, another important aspect of the present invention stems from the ability of the banner 18 to perform a utilitarian operation as well as producing the fanciful optical illusion discussed herein. That is, by forming the banner 18 from a mesh or weaved material, the banner 18 is capable of ‘airing out’ a garage, or the like, while also performing its intended deceptive objective. Still further, the banner 18 may be easily pushed aside for ready access to the garage behind, without damaging either the building structure, or the optical impression of the banner 18 itself.

It is still yet another important aspect of the present invention that the banner 18 not only provides an optical illusion for aesthetic, beautification or entertainment purposes, but also permits a user to open their structure to the flow of ambient air without permitting casual observers to look into the structure and view the contents therein. Therefore, the present invention provides a level of personal privacy not heretofore known in the art, without complicating the ease of use of the structure or sacrificing the ability to selectively expose the interior of the structure to desirable environmental conditions.

FIG. 2 illustrates two possible fastening means for fastening the banner 18 to the bottom portion 20 of the garage door 12. As shown in FIG. 2, the banner 18 may have a plurality of grommets 22, or the like, formed along the top portion of the banner 18. The grommets 22 may be utilized to hang the banner 18 from the bottom portion 20 of the garage door 12, via hooks, nails or other protrusion disposed thereon. FIG. 2 also depicts an alternative fastening strip 24 formed along the top portion of the banner 18. In this alternative embodiment, the fastening strip 24, which may be a hook and latch configuration, or the like, may be adhered to a respective and similar strip affixed to the bottom portion 20 (see FIG. 1) of the garage door 12 so as to permit the banner 18 to hang therefrom.

It is also contemplated by the present invention that a series of strong magnets, or a magnetic strip, may be formed, interwoven or otherwise affixed to the banner 18 so as to permit the banner to hang from the bottom portion 20 of a metallic garage door 12. When so fashioned, the magnetic strip may be disposed in accordance with the fastening strip 24, while the use of discrete, strong magnets may be spaced from one another in accordance with the placement of the grommets 22.

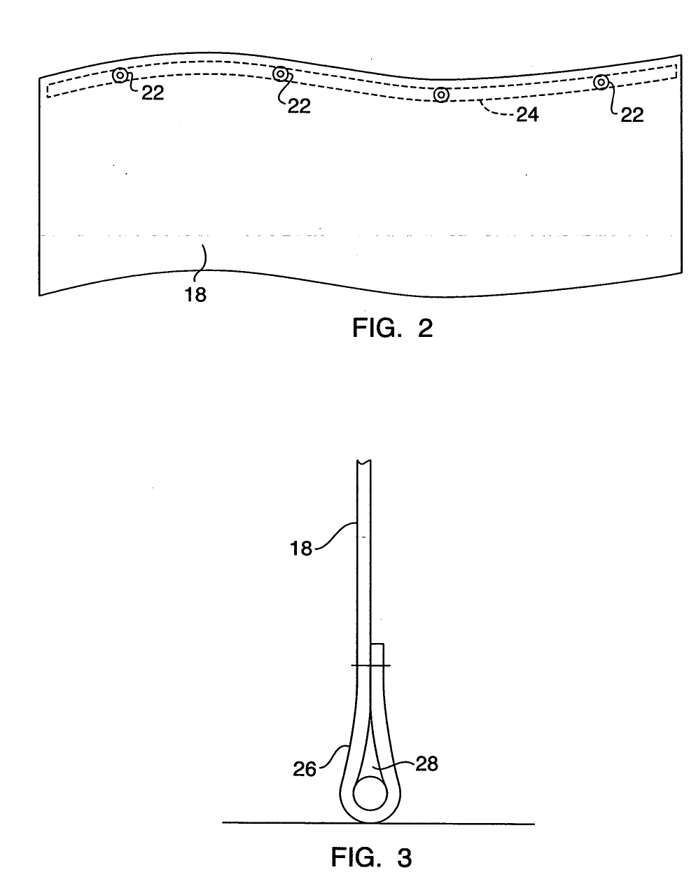

FIG. 3 is a cross-sectional view the garage door banner 18 depicting an integral biasing means for maintaining the banner 18 in a substantially unfurled state. As shown in FIG. 3, and in accordance with one embodiment of the present invention, the banner 18 includes a compartment 26 formed along the longitudinal bottom portion of the banner 18. The compartment 26 may be formed by folding the fabric of the banner 18 such that a cavity 28 is defined within the compartment 26, although other equivalent methods may be utilized without departing from the broader aspects of the resent invention.

Returning to FIG. 3, in order to maintain the banner 18 in an unfurled state, the cavity 28 of the compartment 26 may be filled with sand, stone, or any other material, provided that the chosen material exhibits a sufficient downward weight to maintain the banner 18 in the unfurled state. Alternatively, the present invention also contemplates placing a metal or wooden bar, or the like, within the cavity 28 to provide the downward biasing force to the banner 18.

It will be readily appreciated that the cavity 28 need not be continuous along the longitudinal bottom portion of the banner 18, and may instead be formed at discrete locations along the bottom of the banner 18. Moreover, the present invention also contemplates sewing or otherwise integrating discrete or continuous weights in the bottom portion of the banner 18 in order to provide the necessary biasing means.

While FIGS. 1-3 illustrate a garage door banner 18 which is capable of being mounted to the underside of a garage door to provide thereby the optical illusion of the garage housing a fanciful vehicle, animal or the like, the present invention is not limited in this regard. That is, the present invention also contemplates having a banner which is capable of covering the entire garage door opening such that the banner not only depicts the fanciful vehicle, or the like, but also depicts the top portion of a garage door itself. Referring to FIG. 1 again, an alternative embodiment of the present invention would entail forming the panels 30 of the garage door 12 upon the banner 18, as well as the fanciful image of the vehicle. In this alternative embodiment, the banner 18 would then be affixed to the frame of the garage area 10. As will be appreciated, by depicting the garage door, as well as the fanciful image, upon the banner 18, the present invention permits an infinite array of possible images and styles, the juxtaposition of which may be tailored to the particular personality of the user.

Moreover, although the present invention has been described in connection with a single banner 18 depicting the optical illusion desired, the present invention equally contemplates the synergistic use of two or more banners to create or magnify the optical illusion.

As will be appreciated by consideration of the embodiments illustrated in FIGS. 1-3, the present invention provides a structural opening banner that creates an optical illusion of a fanciful nature, and which is economical and easy to assemble and dissemble. Moreover, the present invention provides a method and apparatus for creating the optical illusion which does not hinder the use of the structural opening provided with the banner. Indeed, the present invention permits the creation of an optical illusion while at the same time preserving the privacy of the contents of the structure, and permitting the influx of ambient air into the structure, for ventilation and the like.

While the present invention has been described in connection with hanging the banner 18 in a structural opening of a building, the present invention is not so limited in this regard. Indeed, the banner 18 may alternatively be hung against the side of a building not defining an opening, or in the opening of a building, such as a garage opening, even when the garage door itself is in the closed position.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

What is claimed is:

1. An apparatus for creating an optical illusion in the structural opening of a building, said apparatus comprising:
a flexible web having an image disposed thereon;
fastening means integrally formed with said flexible web, said fastening means operatively interacting with said structural opening to selectively fasten said flexible web to structural opening; and
integral biasing means formed with said flexible web for biasing said flexible web in an unfurled manner.

2. The apparatus according to claim 1, wherein:
said fastening means and said integral biasing means are disposed on opposing edges of said flexible web.

3. The apparatus according to claim 1, wherein:
said fastening means comprises grommets formed adjacent one edge of said flexible web.

4. The apparatus according to claim 1, wherein:
said fastening means comprises a hook and loop portion formed adjacent one edge of said flexible web.

5. The apparatus according to claim 1, wherein:
said integral biasing means comprises a weighted compartment formed adjacent one edge of said flexible web.

6. The apparatus according to claim 5, wherein:
said weighted compartment is partially filled with one of sand and stone.

7. The apparatus according to claim 5, wherein:
said weighted compartment accommodates one of a metallic rod and wooden rod.

8. The apparatus according to claim 1, wherein:
said image is one of a vehicle, an animal and a nature scene.

9. The apparatus according to claim 1, wherein:
said structural opening is a garage opening for a building.

10. The apparatus according to claim 1, wherein:
said flexible web is formed from a weave to permit a passage of air therethrough.

11. A method of creating an optical illusion in a structural opening of a building, said method comprising the steps of:
forming an image on a flexible web;
integrally forming a fastening means on said flexible web, said fastening means operatively interacting with said structural opening to releasably fasten said flexible web to structural opening; and
defining an integral biasing means on said flexible web for biasing said flexible web in an unfurled manner.

12. The method according to claim 11, further comprising the steps of:
forming said fastening means and said integral biasing means on opposing edges of said flexible web.

13. The method according to claim 11, further comprising the steps of:
defining said fastening means to include grommets formed adjacent one edge of said flexible web.

14. The method according to claim 11, further comprising the steps of:
defining said fastening means to includes a hook and loop strip formed adjacent one edge of said flexible web.

15. The method according to claim 11, further comprising the steps of:
forming said integral biasing means to include a weighted compartment formed adjacent one edge of said flexible web.

16. The method according to claim 15, further comprising the steps of:
partially filling said weighted compartment with one of sand and stone.

17. The method according to claim 15, further comprising the steps of:
accommodating one of a metallic rod and wooden rod in said weighted compartment.

18. The method according to claim 11, further comprising the steps of:
defining said image to include one of a vehicle, an animal and a nature scene.

19. The method according to claim 11, further comprising the steps of:
hanging said flexible web in a garage opening of said building.

20. An apparatus for creating an optical illusion in a garage opening of a building, said apparatus comprising:
a banner having a fanciful image imprinted thereon;
fastening means integrally formed adjacent a first edge said banner, said fastening means operatively interacting with said garage opening to selectively fasten said banner to structural opening; and
integral biasing means formed adjacent a second edge of said banner for biasing said banner in an unfurled manner, said first edge and said second sedge being disposed on opposing sides of said banner.
